(19) United States
(12) Patent Application Publication
(10) Pub. No.: US 2007/0038874 A1
(43) Pub. Date: Feb. 15, 2007

(54) EMBEDDED CONTROLLER AND COMPUTER SYSTEM WITH THE SAME

(76) Inventors: Tsung-Chih Lin, Taipei County (TW); Pei-Ming Chen, Hsinchu City (TW); Meng-Chi Wu, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,891

(22) Filed: Nov. 3, 2005

(30) Foreign Application Priority Data
Aug. 12, 2005 (TW) 94127465

(51) Int. Cl. G06F 1/00

(52) U.S. Cl. 713/300

(57) ABSTRACT

An embedded controller and a computer system with the same are provided. The embedded controller includes a control unit and a firmware. The embedded controller also has a memory device embedded therein or connected thereto. By a synchronal software tool or a driver, the personal information data stored in the personal information software is synchronized with the data stored in the memory device of the embedded controller. When the computer is shut down or is in a sleeping mode, the embedded controller takes over handling the events scheduled in the personal information software. Whenever any scheduled event occurs, the embedded controller notifies the user by a sound or a displayed message. The embedded controller can also synchronize the data stored in the memory device with a hand-held device connected to the computer system when the computer is shut down or in a sleeping mode.

### CROSS-REFERENCE TO RELATED APPLICATION

This application claims the priority benefit of Taiwan application serial no. 94127465, filed on Aug. 12, 2005. All disclosure of the Taiwan application is incorporated herein by reference.

### BACKGROUND OF THE INVENTION

1. Field of Invention

The present invention relates to an embedded controller and a computer system with the same. More particularly, the present invention relates to an embedded controller which may take over handling the events scheduled in the personal information software when the computer is shut down and a computer system with the same.

2. Description of Related Art

With rapid advancement of the electronic technology industry, multifunctional computers have gradually entered our work and daily life. In comparison with desktop computers, notebook computers appeal more to customers because of their advantage of portability. Since the embedded specifications of notebook computers are predetermined, any functional upgrade has to be done through peripheral devices.

An example of expanding the functions of notebook computers to make them more extensive and diverse is described in “Rapid Access to Data On a Powered Down Personal Computer,” U.S. Patent Application No 2004/0030878A1. Referring to FIG. 1, when the computer is shut down or in an energy-saving mode (e.g. sleeping mode), the user's data 110 is read through add-in component 120 and is converted into a document of hypertext markup language (HTML) format, and is read through the BIOS-started browser 140. However, it's inevitable that in this architecture, the BIOS firmware still has to be started, thus this architecture is still energy consuming. And, the conversion to HTML format is not applicable to all types of documents.

There is another example of upgrading notebook computers described in “Keyboard Controller With Integrated Real Time Clock Functionality And Method Therefore,” U.S. Pat. No. 5,854,915. A real time clock (RTC) emulator 215 is disposed in the microprocessor 210 of the embedded controller 200. Since the RTC emulator 215 is separated from the computer system and its chipset, the computer system can operate even if it is shut down or in a sleeping mode, and the power thereof is provided by battery. The microprocessor 210 may transfer data to and receive data from the memory unit 230 and control some peripheral devices, such as keyboard and mouse, through the external bus 220. Also, the microprocessor 210 has boot function. The memory unit 230 further has a time register 232 for registering time information sent by the microprocessor 210. And then the time information is sent to the computer system through system processor bus. Therefore, correct time information may be provided to the computer system.

### SUMMARY OF THE INVENTION

Accordingly, the present invention is directed to provide an embedded controller including at least a control unit and a firmware. The embedded controller also has a memory device embedded therein or connected thereto. By a synchronal software tool or a driver, the personal information data stored in the personal information software is synchronized with the data stored in the memory device of the embedded controller. When the computer is shut down, the embedded controller will take over handling the events scheduled in the personal information software.

When an event stored in the memory device of the embedded controller occurs, the embedded controller may drive the audio notification circuit to produce a corresponding ring tone or sound to notify the user. Therefore, the user would know the events scheduled in the personal information without starting up the computer, such that the user's time is saved and the electricity consumption is reduced. Moreover, a hand-held device may be connected to perform the transmission operation when the computer is shut down. Furthermore, an event may be optionally displayed on the display device when an event is detected. Therefore, the user would know the content of the events scheduled in the personal information without turning on the computer.

In order to make the aforementioned and other objects, features and advantages of the present invention comprehensible, embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating the architecture of a conventional notebook computer.

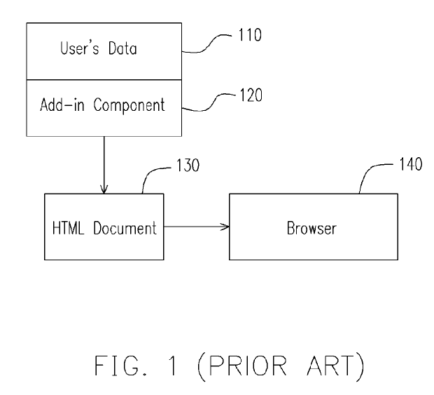

FIG. 2 is a diagram illustrating a conventional embedded controller.

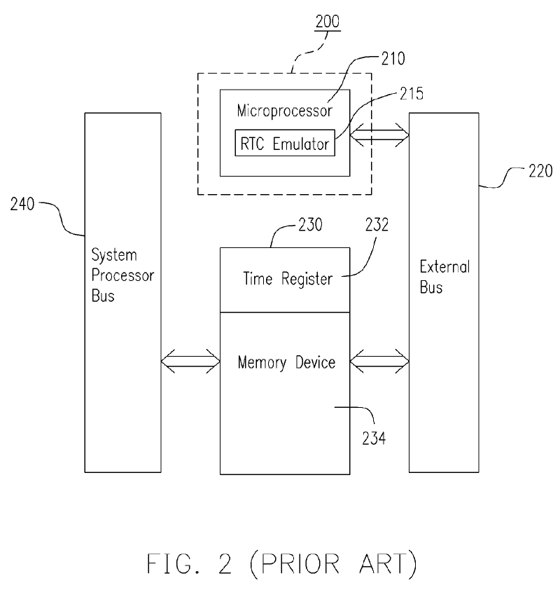

FIG. 3 is a diagram illustrating the architecture of a computer according to an embodiment of the present invention.

FIG. 4 is an operation flowchart of a computer system having an embedded controller according to an embodiment of the present invention.

FIG. 5 is a monitoring flowchart of a computer system having an embedded controller according to an embodiment of the present invention.

### DESCRIPTION OF EMBODIMENTS

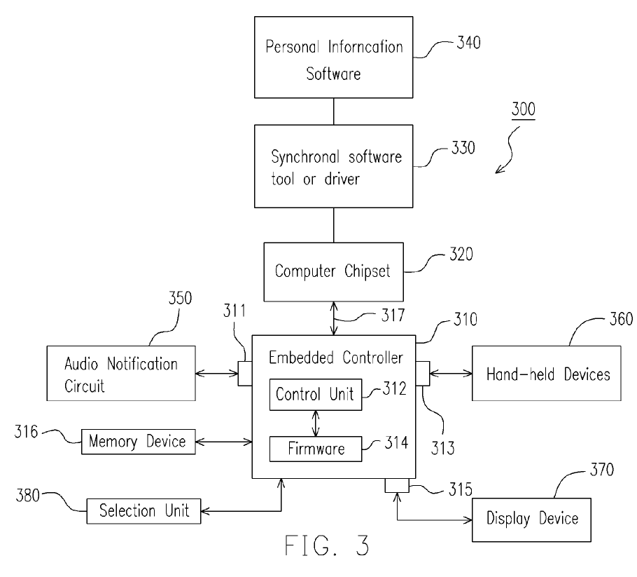

The present invention provides a computer architecture. The computer 300 has an embedded controller 310. Referring to FIG. 3, the embedded controller 310 has a control unit 312 such as a microcontroller, and a firmware 314 connected to the computer chipset 320 through the bus interface 31 7. The embedded controller 310 has a memory device embedded therein or connected thereto. An externally connected memory (316) is exemplified in the figure though the memory may also be embedded in the embedded controller 310. The embedded controller 310 may include the function of a keyboard controller. By a synchronal software tool or a driver 330, the personal information data stored in the personal information software 340 is synchronized with the data stored in the memory device of the embedded controller 310. When the computer is shut down or is in an energy-saving mode (e.g. sleeping mode), the embedded controller 310 will take over handling the events scheduled in the personal information software 340. And events or related data stored in the personal information, e.g. group record, contact list, e-mail, date or time etc., may be stored.

Further, the embedded controller 310 has a connection interface 311, e.g. a parallel interface or a serial interface, for connecting an audio notification circuit 350. The audio notification circuit 350 may be a polyphonic ring tone IC, a voice or speech IC, or a buzzer. When an event scheduled in the personal information software 340 occurs, that is, the data has been stored synchronously into the memory device 316 of the embedded controller 310, the embedded controller 310 may drive the audio notification circuit 350 to produce a corresponding ring tone or sound to notify the user. Therefore the user would know the events stored in the personal information without starting up the computer, such that the user's time is saved and the electricity consumption is reduced as well.

Furthermore, the embedded controller 310 has another connection interface 313, which may be a universal serial bus (USB) port, COM port, infrared ray (IR) interface, blue tooth, or user define interface etc., for connecting to the user's hand-held device 360. The hand-held device 360 maybe a personal digital assistant (PDA) or a mobile phone. The connection to the user's hand-held device 360 may be provided through the connection interface 31 3 which performs the transmission operation when the computer 300 is shut down or is in a sleeping mode. When the personal information data stored in the personal information software 340 is synchronized with the data stored in the memory device of the embedded controller 310, and the computer system is shut down or in energy-saving status, the embedded controller 310 will take over handling the events scheduled in the personal information software 340, and the hand-held device 360 may download the data stored in the personal information software 340, including user scheduled events and timetable or related data stored in the personal information as group record, contact list, e-mails, calculator, date or time etc., through the connection interface 31 3. The computer needs not to be turned on to avoid wasting time and electricity.

The embedded controller 310 has another connection interface 315 for connecting to a display device 370. The display device 370 may be a light-emitting diode (LED) display device, a liquid crystal display (LCD) device, or any other visible display device. When an event scheduled in the personal information software 340 occurs, or has been stored synchronously into the memory device 316 of the embedded controller 310, the embedded controller 310 may optionally drive the audio notification circuit 350 to produce a corresponding ring tone or sound to notify the user, or optionally display the event on the display device 370. Therefore, the user would know the content of the events scheduled in the personal information without turning on the computer.

The embedded controller 310 is connected to a selection unit 380 for responding the options of executing an event when the embedded controller 310 is taking over handling the event scheduled in the personal information software 340. The selection unit 380 may be, for example, a group of buttons used for responding the user's selections and sending the selected options back to the embedded controller 310. The selection unit 380 may also be embedded in the keyboard of the computer 300.

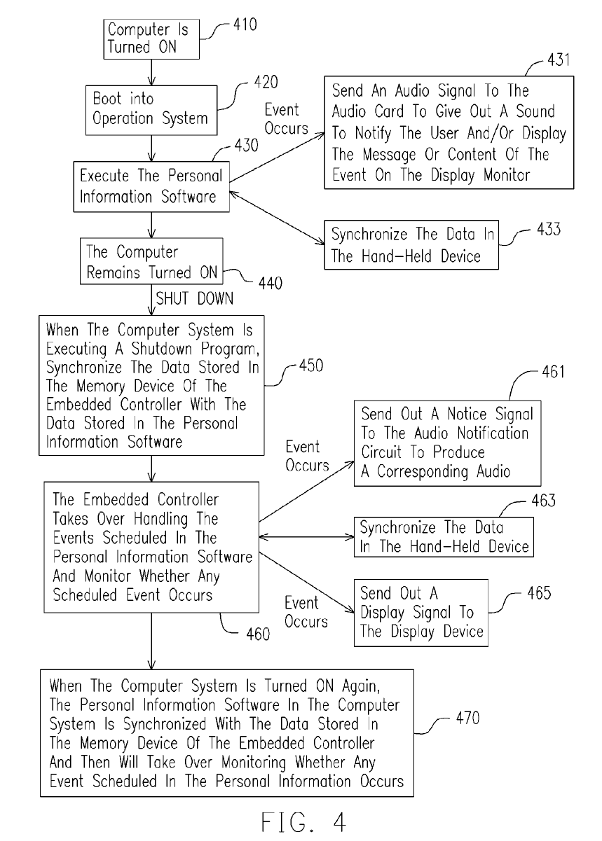

The operation flow of a computer system having the embedded controller according to an embodiment of the present invention is illustrated in FIG. 4. First, the computer is turned on in step 410. Next, in step 420, the computer system boots into operation system. When the user is executing the personal information software in step 430, the personal information software will monitor whether any scheduled event occurs and then notify the user. For example, the computer would send an audio signal to the computer's audio card to send out a sound to notify the user, or display the message or content of the event on the display monitor in step 431. Moreover, in step 433, if the user connects a hand-held device to the computer system through a connection port, the data in the hand-held device may be synchronized with data stored in the personal information software. And in step 440, if the computer remains turned on, then it may execute the personal information software constantly to monitor the occurrence of events.

The following is an operation flowchart of when the computer system is to be shut down; that is, the computer system is executing a shutdown program. Certainly, the present invention also applies to an energy-saving mode (e.g. sleeping mode), but only the shutdown operation is exemplified in the present embodiment. When the computer system shuts down, the embedded controller synchronizes the data stored in the personal information software in step 450. For example, the events scheduled in the personal information software or data of contact list stored in the personal information is synchronized with the data stored in the memory device of the embedded controller. After that, in step 460, the embedded controller will take over handling the events scheduled in the personal information software and monitor whether any scheduled event occurs.

Once the embedded controller finds occurrence of any event, it sends out a notice signal to the audio notification circuit to produce a corresponding audio in step 461. This audio includes ring tone generated by the polyphonic ring tone IC, a corresponding voice generated by a voice or speech IC, or a sound generated by a buzzer. The user is notified of the event by the generated ring tone or sound. Therefore the user would know the scheduled events stored in the personal information without turning on the computer, which saves the user's time and reduce energy consumption.

If the embedded controller detects that a hand-held device is connected through a transmission interface, after the confirmation by the user, the hand-held device may download the data stored in the memory device of the embedded controller, such as events and timetable scheduled by the user or data stored in the personal information as group record, contact list, e-mails, calculator, date or time etc, through the connection interface, without turning on the computer. Operation of data synchronization may also be performed in step 463.

In the selected embodiment, when an event scheduled in the personal information software occurs, that is, an event synchronously stored in the memory device of the embedded controller occurs, the embedded controller may optionally drive the audio notification circuit to produce a corresponding ring tone or sound to notify the user, or also optionally display the event on the display device in step 465. Therefore, the user would know the content of the scheduled event stored in the personal information without turning on the computer.

When the computer system is turned on again in step 470, the personal information software in the computer system will be synchronized with the data stored in the memory device of the embedded controller and then will take over monitoring whether any event scheduled in the personal information occurs. That is, once the occurrence of an event is detected, the user will be notified by the displayed event on the display device or by a sound.

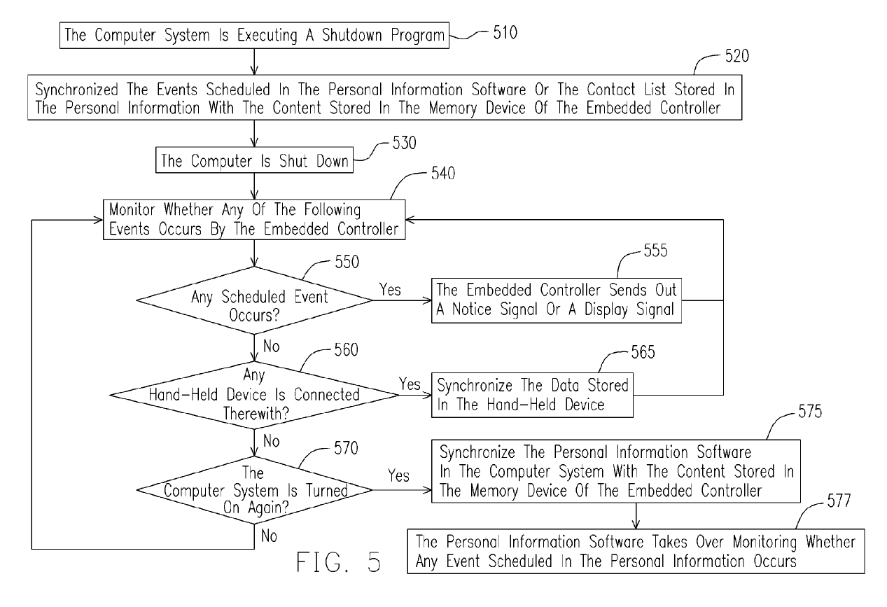

The operation flow and monitoring manner of the embedded controller according to an embodiment of the present invention are described in FIG. 5. First, in step 510, when the computer is shut down, that is, the computer system is executing shutdown program, the events scheduled in the personal information software or the contact list stored in the personal information are synchronized with the content stored in the memory device of the embedded controller, in the following step 520. After that, in the following step 530, the computer is shut down. Here the embedded controller will take over handling the events scheduled in the personal information software and monitor whether any of the following events occurs, in step 540.

First, the embedded controller determines whether any scheduled event occurs in step 550. If an event occurs, the process goes to step 555; that is, the embedded controller sends out a notice signal to the audio notification circuit to produce a corresponding audio, or sends a displaying signal to the display device to display the related content of the event. Otherwise, the process goes to step 560.

Next, in step 560, the embedded controller monitors whether there is any hand-held device connected through the transmission interface. If yes, then the process goes to step 565; that is, after the user's confirmation, the hand-held device may download the data stored in the memory device of the embedded controller, such as scheduled events or timetable or related data stored in the personal information as group record and contact list etc, through the connection interface, without turning on the computer. The operation of data synchronization may also be performed. If no, then the process goes to step 570.

Next, it is determined whether the computer system is turned on again in step 570. If yes, then the process goes to step 575. That is, the personal information software in the computer system is synchronized with the content stored in the memory device of the embedded controller. After that, the embedded controller takes over monitoring whether any event occurs in step 577; that is, once the occurrence of an event is detected, the user will be notified by the displayed event on the display monitor or a sound.

In summary, the present invention provides an embedded controller including at least a control unit and a firmware. The embedded controller also has a memory device embedded therein or connected thereto. By a synchronal software tool or a driver, the personal information data stored in the personal information software is synchronized with the data stored in the memory device of the embedded controller. When the computer is shut down, the embedded controller will take over handling the events scheduled in the personal information software.

When an event stored in the memory device of the embedded controller occurs, the embedded controller may drive the audio notification circuit to produce a corresponding ring tone or voice to notify the user. Therefore, the user would know the scheduled events without turning on the computer, which saves the user's time and reduce electricity consumption as well. Moreover, a hand-held device may be connected to perform the transmission operation when the computer is shut down. Furthermore, the event may also be displayed on the display device when an event occurrence is detected. Thus, the user would know the content of the scheduled events without turning on the computer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An embedded controller for a computer system, suitable for a computer system; the embedded controller comprising:
a programmed firmware unit for initializing a plurality of periphery devices;
a control unit for controlling the periphery devices;
a memory device for storing a personal information data;
a synchronal software tool for synchronizing the data stored in the personal information software in the computer system with the personal information data stored in the memory device, such that when the computer system is shut down or is in energy-saving mode, the control unit takes over handling the events scheduled in the personal information software in the computer system.

2. The embedded controller as claimed in claim 1 further comprising a first connection interface for connecting an audio notification circuit, wherein when the computer system is shut down or entering an energy-saving mode, the embedded controller, upon detecting that an event of the personal information data occurs, sends out an audio signal to the audio notification circuit to produce a corresponding sound to notify the user.

3. The embedded controller as claimed in claim 2, wherein the first connection interface is a parallel interface or a serial interface.

4. The embedded controller as claimed in claim 2, wherein the audio notification circuit is a polyphonic ring tone IC, a voice or speech IC, or a buzzer.

5. The embedded controller as claimed in claim 1, further comprising a second connection interface for connecting a hand-held device, such that when the computer system is shut down or entering an energy-saving mode, the embedded controller starts to detect whether the hand-held device is connected through the second connection interface, and if it's connected, the personal information data stored in the memory device is transferred to the hand-held device under the control of the embedded controller.

6. The embedded controller as claimed in claim 5, wherein the second connection interface is an universal serial bus (USB) connection interface, a COM connection interface, an infrared ray (IR) interface, a blue tooth interface, or an user define interface.

7. The embedded controller as claimed in claim 5, wherein the hand-held device is a personal digital assistant (PDA) or a mobile phone.

8. The embedded controller as claimed in claim 1, further comprising a third connection interface for connecting a display device, wherein when the computer system is shut down or entering an energy saving mode, if the embedded controller detects that an event of the personal information data occurs, the content of the event is displayed on the display device.

9. The embedded controller as claimed in claim 8, wherein the display device is a light-emitting diode (LED) display device or a liquid crystal display (LCD) device.

10. The embedded controller as claimed in claim 1, further comprising a selection unit for responding the options of executing an event when the embedded controller takes over handling the event.

11. The embedded controller as claimed in claim 10, wherein the selection unit comprises a group of buttons used for responding the user's selections, or comprises a keyboard of the computer system.

12. The embedded controller as claimed in claim 1, wherein the personal information includes calendar, e-mail, calculator, date or time.

13. The embedded controller as claimed in claim 1, wherein the control unit is a microcontroller.

14. A computer system, comprising:
a personal information software;
a synchronal software tool; and
an embedded controller, comprising:
a programmed firmware device for initializing a plurality of periphery devices;
a control unit for controlling the periphery devices; and
a memory device for storing a personal information data, wherein by the synchronal software, the personal information data stored in the personal information software in the computer system is synchronized with the data stored in the memory device, and when the computer system is shut down or entering an energy-saving mode, the control unit takes over handling the events scheduled in the personal information software in the computer system.

15. The computer system as claimed in claim 14, further comprising an audio notification circuit connected to the embedded controller through a first connection interface of the embedded controller, wherein when the computer system is shut down or entering an energy-saving mode, if the embedded controller detects that an event in the personal information data occurs, an audio signal is sent to the audio notification circuit to produce a corresponding sound to notify the user.

16. The computer system as claimed in claim 15, wherein the first connection interface is a parallel interface or a serial interface.

17. The computer system as claimed in claim 15, wherein the audio notification circuit is a polyphonic ring tone IC, a voice or speech IC, or a buzzer.

18. The computer system as claimed in claim 14, wherein the embedded controller further includes a second connection interface for connecting a hand-held device, such that when the computer system is shut down or entering an energy-saving mode, the embedded controller starts detecting whether the hand-held device is connected through the second connection interface, and if the hand-held device is connected, the personal information data stored in the memory device is transferred to the hand-held device under the control of the embedded controller.

19. The computer system as claimed in claim 18, wherein the second connection interface is an universal serial bus (USB) connection interface, a COM connection interface, an infrared ray (IR) interface, a blue tooth interface, or an user define interface.

20. The computer system as claimed in claim 18, wherein the hand-held device is a personal digital assistant (PDA) or a mobile phone.

21. The computer system as claimed in claim 14, further comprising a display device connected to the embedded controller through a third connection interface of the embedded controller, such that when the computer system is shut down or entering an energy-saving mode, if the embedded controller detects(that) an event in the personal information data occurs, the content of the event is displayed on the display device.

22. The computer system as claimed in claim 21, wherein the display device is a light-emitting diode (LED) display device or a liquid crystal display (LCD) device.

23. The computer system as claimed in claim 14, further comprising a selection unit for allowing the user to select the options of executing an event when the embedded controller takes over handling the event.

24. The computer system as claimed in claim 23, wherein the selection unit comprises a group of buttons used for responding the user's selection, or comprises a keyboard of the computer system.

25. The computer system as claimed in claim 14, wherein the personal information comprises calendar, e-mail, calculator, date or time.

26. The computer system as claimed in claim 14, wherein the control unit is a microcontroller.
